(19) United States
(12) Patent Application Publication
(10) Pub. No.: US 2014/0149991 A1
(43) Pub. Date: May 29, 2014

(54) SCHEDULING SYSTEM, DATA PROCESSING SYSTEM, AND SCHEDULING METHOD

(71) Applicant: FUJITSU LIMITED, Kawasaki-shi (JP)

(72) Inventors: Toshiya Otomo, Kawasaki (JP); Koichiro Yamashita, Hachioji (JP); Takahisa Suzuki, Yokohama (JP); Hiromasa Yamauchi, Usakos (NA); Koji Kurihara, Kawasaki (JP)

(73) Assignee: FUJITSU LIMITED, Kawasaki-shi (JP)

(21) Appl. No.: 14/170,144

(22) Filed: Jan. 31, 2014

Related U.S. Application Data
(63) Continuation of application No. PCT/JP2011/069344, filed on Aug. 26, 2011.

(51) Int. Cl. G06F 9/50

(52) U.S. Cl. CPC G06F 9/5027; G06F 9/505
USPC 718/104

(57) ABSTRACT

A scheduling system includes a processor that is configured to assign a process to at least one data processing system among plural data processing systems, based on an execution request for the process; estimate time consumed for completion of a first process, when the process is the first process; and append specific information to the first process, based on the estimated time.

### CROSS REFERENCE TO RELATED APPLICATIONS

This application is a continuation application of International Application PCT/JP2011/069344, filed on Aug. 26, 2011 and designating the U.S., the entire contents of which are incorporated herein by reference.

### FIELD

The embodiments discussed herein are related to a scheduling system, a data processing system, and a scheduling method.

### BACKGROUND

Conventionally, distributed processing techniques are known that respectively handle multiple computing devices in a collective manner such as in grid computing. For example, in a pushed, distributed processing system, a master terminal continuously collects parameters of the execution state of a process at computing terminals (parameter collection) and thereby, performs scheduling that considers the state of the computing terminals (for example, refer to Japanese Laid-Open Patent Publication No. 2008-152618).

Among processes that are executed by distributed processing, processes are present that have real-time constraints requiring process completion within a limited time period. Meanwhile, advancements in the performance of mobile terminals are startling; the computing performance of central processing units (CPUs) and the speed of wireless communication are improving.

Nonetheless, with the techniques above, when a distributed processing system of mobile terminals as nodes is built and parameter collection accompanying communication is performed continuously, battery consumption of the mobile terminal becomes great. On the contrary, although assignment of the processes without performing parameter collection may be considered, suitable scheduling cannot be performed, resulting in a higher potential of assignment refusal and consequently, processing delays. Further, although performing parameter collection at the time of process assignment may be considered, the problem of processing delays arises consequent to the time consumed for parameter collection.

### SUMMARY

According to an aspect of an embodiment, a scheduling system includes a processor that is configured to assign a process to at least one data processing system among plural data processing systems, based on an execution request for the process; estimate time consumed for completion of a first process, when the process is the first process; and append specific information to the first process, based on the estimated time.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example of a communications system according to an embodiment;

FIG. 2 is a diagram depicting an example of a hardware configuration of apparatuses;

FIG. 3 is a diagram depicting an example of estimated time;

FIG. 4 is a diagram depicting an example of application of a communications system;

FIG. 5 is a flowchart of a procedure performed by a master terminal;

FIG. 6 is a flowchart of one example of a parameter collection procedure performed by the master terminal;

FIG. 7 is a flowchart of an example of a procedure performed by a computing terminal;

FIG. 8A is a diagram depicting an example of operation of the communications system when the estimated time is within a specified period; and

FIG. 8B is a diagram depicting an example of operation of the communications system when the estimated time exceeds the specified period.

### DESCRIPTION OF EMBODIMENTS

Embodiments of a scheduling system, a data processing system, and a scheduling method will be described in detail with reference to the accompanying drawings.

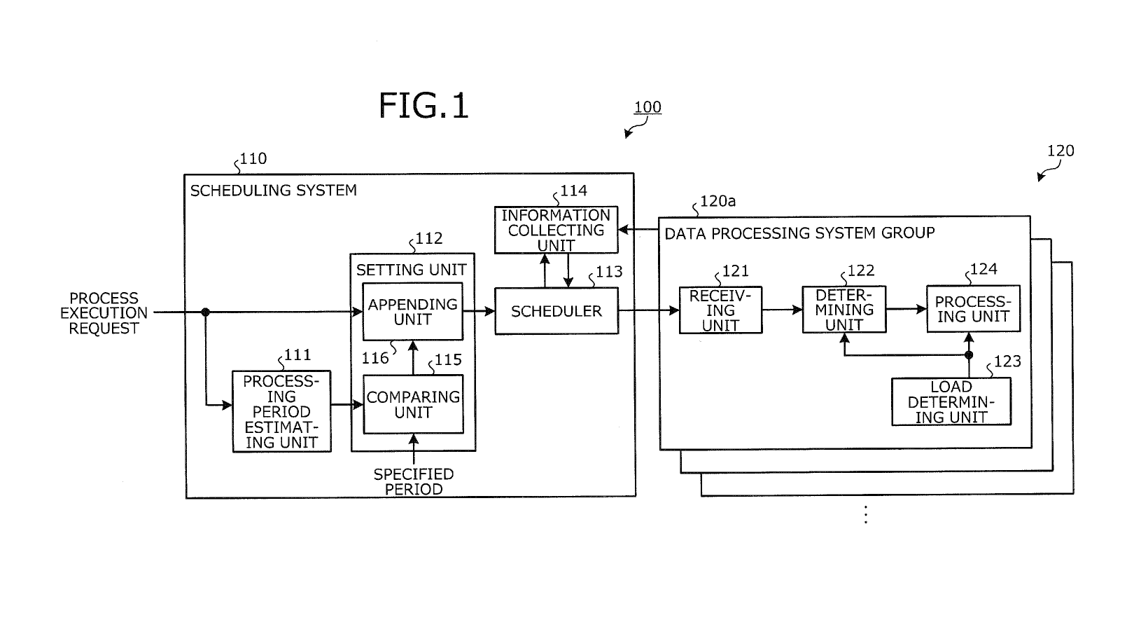

FIG. 1 is a diagram depicting an example of a communications system according to an embodiment. As depicted in FIG. 1, a communications system 100 according to the embodiment includes a scheduling system 110 and a data processing system group 120. The scheduling system 110 and the data processing system group 120 are, for example, mobile terminals that can mutually communicate by ad hoc communication.

The scheduling system 110 (first data processing system) is a data processing system that based on an input execution request for a process, performs process assignment and thereby, causes at least one data processing system (second data processing system) of the data processing system group 120 to execute the processing. For example, the scheduling system 110 performs distributed processing of distributing and assigning processing to multiple data processing systems in the data processing system group 120. An example of distributed processing is, for instance, Globus Toolkit.

Further, the scheduling system 110 may assign the processing to a single data processing system in the data processing system group 120. The scheduling system 110 may be configured to receive execution results of the processing from each data processing system assigned the processing among the data processing system group 120.

The data processing system group 120 includes data processing systems that can communicate with the scheduling system 110. At least one data processing system in the data processing system group 120 executes processing assigned by the scheduling system 110. Further, a data processing system among the data processing system group 120 and to which processing has been assigned by the scheduling system 110 may transmit execution results of the processing to the scheduling system 110.

The scheduling system 110 includes a processing period estimating unit 111, a setting unit 112, and a scheduler 113. The scheduling system 110 may further include an information collecting unit 114. Here, the scheduling system 110 is assumed to assign processing to a data processing system 120a included in the data processing system group 120. The processing period estimating unit 111 and the setting unit 112 receive input of an execution request for processing that is assigned by the scheduling system 110 to at least one data processing system in the data processing system group 120.

When the processing for which an execution request has been received is for a first process, the processing period estimating unit 111 estimates the time that will be consumed until completion of the first process, which has been assigned to the data processing system 120a. The first process is, for example, is a highly urgent process for which a constraint has been set prescribing completion within a specified period. An instance of highly urgent, distributed processing includes a process such as that for high-resolution video chatting with high compression and for which execution in real-time is required and expansion processing is heavy consequent to the high compression. The processing period estimating unit 111 outputs the estimated time to the setting unit 112.

The setting unit 112 appends specific information to the input execution request, based on the estimated time output from the processing period estimating unit 111. The specific information includes, for example, information (forced flag) indicating that the first process is forcibly executed. The setting unit 112 includes, for example, a comparing unit 115 and an appending unit 116.

The comparing unit 115 compares the estimated time output from the processing period estimating unit 111 and the specified period. The specified period is, for example, a time constraint of the first process. In other words, the comparing unit 115 is, thus, able to determine whether the first process can be completed within the time constraint. The comparing unit 115 outputs the comparison result to the appending unit 116.

The appending unit 116 appends the specific information to the input execution request, based on the comparison result output from the comparing unit 115. For example, if the comparison result from the comparing unit 115 indicates that the estimated time is greater than or equal to the specified period, the appending unit 116 appends the specific information to the execution request for the first process.

If the comparison result from the comparing unit 115 indicates that the estimated time is less than the specified period, the appending unit 116 appends no specific information to the execution request of the first process. Further, the appending unit 116 appends no specific information execution requests for processes other than the first process. The appending unit 116 outputs the execution request to the scheduler 113, with or without appending specific information.

The scheduler 113 assigns the process indicated in the execution request output from the setting unit 112, to at least one data processing system in the data processing system group 120. The scheduler 113 may assign the process, based on information output from the information collecting unit 114. In the present example, the scheduler 113 assigns the process to the data processing system 120a, which is included in the data processing system group 120. The scheduler 113 outputs process assignment information that instructs the execution of the process assigned to the data processing system 120a. The process assignment information output from the scheduler 113 is, for example, transmitted to the data processing system 120a by a communications unit (not depicted).

The information collecting unit 114 collects information of data processing systems included in the data processing system group 120. The information collected by the information collecting unit 114 is, for example, a parameter that indicates the state of, for instance, the load of the data processing system group 120 (e.g., processor utilization rate, number of processes under execution, etc.). The parameter, for example, may include information such as the number of the data processing system groups 120 (computing nodes), processing capacity, the volume of processes currently assigned, communication periods with the computing nodes, etc. The information collecting unit 114 outputs the collected information to the scheduler 113. As a result, the scheduler 113 can perform process assignment, based on parameters such as the load of the data processing system group 120.

If an input execution request is for a second process, the processing period estimating unit 111 may estimate a collection period during which the information collecting unit 114 collects information, and a process period that is from the time when the second process is scheduled until execution of the second process is completed. The second process is, for example, a process that does not require completion within a specified period. The processing period estimating unit 111 may calculate the average of the collection period and the process period, and based on the calculated average, estimate the time consumed until execution of the first process is completed.

The data processing system 120a includes a receiving unit 121, a determining unit 122, a load determining unit 123, and a processing unit 124. Data processing systems in the data processing system group 120, other than the data processing system 120a, include the same components as the data processing system 120a, for example.

The receiving unit 121 receives a process assigned by the scheduler 113 of the scheduling system 11. For example, the receiving unit 121 receives process assignment information transmitted from the scheduling system 110. The receiving unit 121 outputs the received execution request to the determining unit 122.

The determining unit 122 determines whether to accept the process indicated by the process assignment information output from the receiving unit 121. For example, the determining unit 122 has a function of a specific information determining unit, which determines whether the specific information is appended to the process assignment information. The determining unit 122 may determine whether to accept the process, based on the load indicated by the load determining unit 123. If the determining unit 122 decides to accept the process, the determining unit 122 outputs the process assignment information to the processing unit 124; and if the determining unit 122 decides not to accept the process, the determining unit refrains from outputting the process assignment information to the processing unit 124.

The load determining unit 123 determines the load of the data processing system 120a (i.e., the data processing system to which the load determining unit 123 belongs). The load, for example, is a parameter of the processor utilization rate, the number of processes under execution, etc. The load determining unit 123 outputs a determination result to the processing unit 124. The data processing system 120a may further transmit to the information collecting unit 114 of the scheduling system 110, the determination result output from the load determining unit 123.

The processing unit 124 executes the process indicated by the process assignment information output from the determining unit 122. If the specific information is appended to the process assignment information, the processing unit 124, based on the determination result output from the load determining unit 123, discards at least one process that has already been assigned.

For example, when process assignment information to which the specific information has been appended is output from the determining unit 122 and the determination result output from the load determining unit 123 indicates that the load exceeds a given value, the processing unit 124 discards at least one process. For example, the processing unit 124 selects the process having a priority level that is lowest among the processes already assigned, and discards the selected process.

Thus, the processing unit 124, based on the load of the data processing system 120a and the presence of the specific information, discards at least one process that has already been assigned. As a result, process assignment information to which the specific information has been appended is received and if the load of the data processing system to which the processing unit 124 belongs is great, the processing unit 124 discards a process other than the process indicated in the process assignment information and thereby, is able to reduce the load. Thus, the processing unit 124 is able to execute the process indicated in the received process assignment information.

Thus, in the communications system 100, when the scheduling system 110 receives an execution request of high urgency, appends a forced command when assigning the process to the data processing system 120a. Further, upon receiving process assignment from the scheduling system 110, the data processing system 120a determines whether a forced command is appended and if a forced command is appended, for example, the data processing system 120a unconditionally accepts the process assignment.

The scheduling system 110 estimates the time to be consumed for a process to be completed in the case of performing parameter collection. If the estimated time is longer than a time constraint, the scheduling system appends a forced command; and if the estimated time is less than or equal to the time constraint, the scheduling system 110 appends no forced command to the process.

Thus, if a process is estimated to not be completed within the time constraint, the process can be assigned in a shorter period of time by not performing parameter collection. Further, delays consequent to assignment refusal can be prevented by prohibiting refusal of an assignment.

Meanwhile, if a process is estimated to be completed within the time constraint, assignment refusal of the process can be prevented by performing parameter collection. Further, by not prohibiting assignment refusal of a process, delays in the completion time of other processes caused by the data processing system 120a becoming overloaded consequent to assignment refusal being prohibited can be prevented. In addition, since parameter collection need not be performed continuously, the power consumption of the scheduling system 110 and the data processing system group 120 can be reduced.

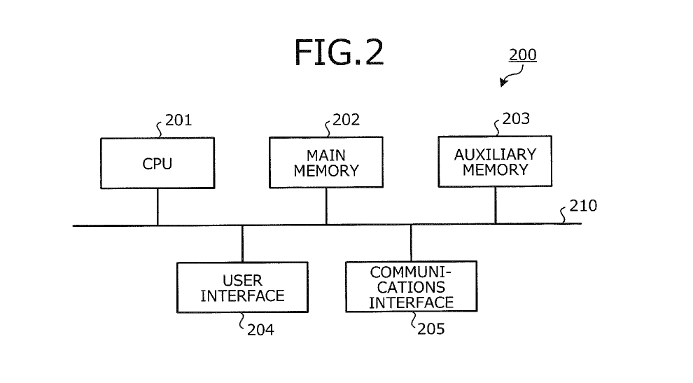

FIG. 2 is a diagram depicting an example of a hardware configuration of the apparatuses. The scheduling system 110 and the data processing system 120a depicted in FIG. 1 may be implemented respectively by an information processing apparatus 200 depicted in FIG. 2. The information processing apparatus 200 includes the CPU 201, main memory 202, auxiliary memory 203, a user interface 204, and a communications interface 205, respectively connected by a bus 210.

The CPU 201 governs overall control of the information processing apparatus 200. Further, the information processing apparatus 200 may include the CPU 201 in plural. The main memory 202 is, for example, random access memory (RAM). The main memory 202 is used as a work area of the CPU 201. The auxiliary memory 203 is non-volatile memory such as a hard disk and flash memory. The auxiliary memory 203 stores various types of programs that cause the information processing apparatus 200 operate. Programs stored in the auxiliary memory 203 are loaded onto the main memory 202 and executed by the CPU 201.

The user interface 204 includes, for example, an input device that receives operational input from the user and an output device that outputs information to the user. The input devices may be implemented by, for example, keys (e.g., a keyboard), a remote controller, etc. The output device may be implemented by, for example, a display, speakers, etc. Further, a touch panel may implement the input device and the output device. The user interface 204 is controlled by the CPU 201.

The communications interface 205 is, for example, a communications interface that performs wireless communication between the information processing apparatus 200 and external devices. For example, the communications interface 205 of the scheduling system 110 wirelessly communicates with the communications interface 205 of the data processing system 120a. The communications interface 205 is controlled by the CPU 201.

In the scheduling system 110 depicted in FIG. 1, an execution request for a process is input by, for example, the user interface 204 or the communications interface 205. Further, the processing period estimating unit 111, the setting unit 112, and the scheduler 113 may be implemented by, for example, a function of an operating system (OS) executed by the CPU 201. The information collecting unit 114 may be implemented by, for example, the communications interface 205. Process assignment information output from the setting unit 112 is transmitted by the communications interface 205 to the data processing system 120a, for example.

In the data processing system 120a depicted in FIG. 1, the receiving unit 121 may be implemented by, for example, the communications interface 205. The determining unit 122, the load determining unit 123, and the processing unit 124 may be implemented by, for example, a function of the OS executed by the CPU 201.

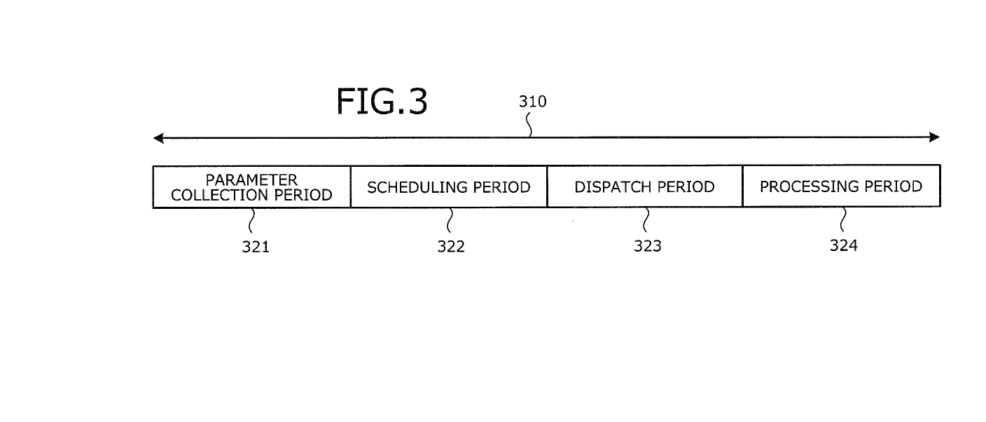

FIG. 3 is a diagram depicting an example of the estimated time. Estimated time 310 depicted in FIG. 3 is the time calculated by the processing period estimating unit 111. As depicted in FIG. 3, the estimated time 310 is a period of time that corresponds to the sum of a parameter collection period 321, a scheduling period 322, a dispatch period 323, and a processing period 324.

The parameter collection period 321 is the period of time consumed for parameter collection by the information collecting unit 114. The processing period estimating unit 111, for example, measures the time consumed by the information collecting unit 114 for parameter collection in the past and can calculate the parameter collection period 321 by averaging the most recent session.

The scheduling period 322 is the period of time consumed by the scheduler 113 for scheduling. The processing period estimating unit 111 can calculate the scheduling period 322, based on a scheduling algorithm, the number of processes, the number of the data processing system groups 120 (computing nodes), etc., for example.

The dispatch period 323 is the period of time consumed by the scheduler 113 for process assignment (dispatch). The processing period estimating unit 111 can calculate the dispatch period 323, based on processing volumes and communication speeds, for example.

The processing period 324 is the period of time consumed, after dispatch of a process, for at least one data processing system among the data processing system group 120 to execute the process and for an execution result to be returned to the scheduling system 110. The processing period estimating unit 111 can calculate the processing period 324, based on the processing volume and the processing capacity of the data processing system group 120, for example. The processing volume is, for example, information included in the execution request for the process. The processing capacity can be calculated by measuring the processing volumes and the completion times of processes performed in the past, and averaging the most recent measurements.

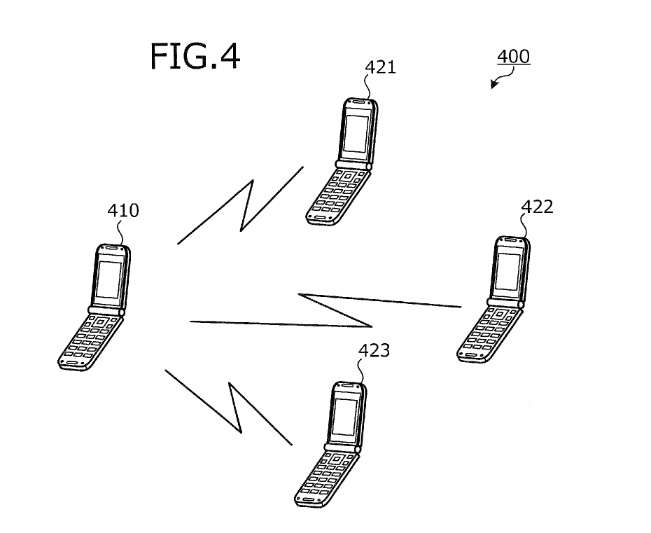

FIG. 4 is a diagram depicting an example of application of the communications system. An ad hoc network 400 depicted in FIG. 4 is a communications system applying the communications system 100 depicted in FIG. 1 is applied. The ad hoc network 400 includes a master terminal 410, and computing terminals 421 to 423. The master terminal 410 and the computing terminals 421 to 423 are wireless communication terminals that are wirelessly connected and perform ad hoc communication.

In the present the master terminal 410 operates as the scheduling system 110 depicted in FIG. 1. Further, the computing terminals 421 to 423 operate as the data processing system group 120 depicted in FIG. 1. For example, the computing terminal 421 corresponds to the data processing system 120a depicted in FIG. 1.

Thus, by applying the communications system 100 to the ad hoc network 400 that performs direct communication between terminals without a base station, even when outside the service area of a base station, the terminals are connected by the ad hoc network 400 and can build a distributed processing system. Hereinafter, a case will be described where the master terminal 410 assigns a process to the computing terminal 421.

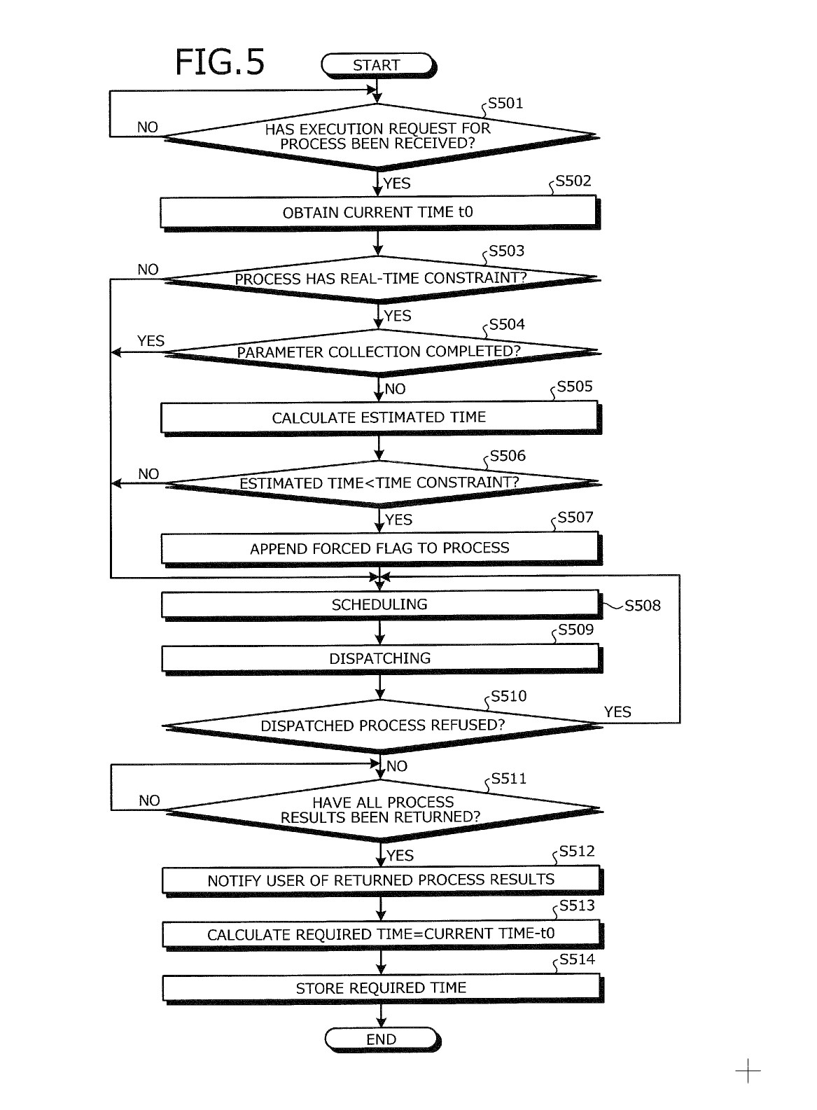

FIG. 5 is a flowchart of a procedure performed by the master terminal. The master terminal 410, for example, executes the steps depicted in FIG. 5. The processing period estimating unit 111 determines whether an execution request for a process has been received (step S501), and if no execution request has been received, waits until an execution request is received (step S501: NO).

At step S501, when an execution request has been received (step S501: YES), the processing period estimating unit 111 obtains the current time t0 (step S502). The processing period estimating unit 111 determines whether the process indicated in the execution request received at step S501 has a real-time constraint (i.e., first process) (step S503).

At step S503, if the process indicated in the execution request has a real-time constraint (step S503: NO), the master terminal 410 proceeds to step S508. If the process indicated in the execution request has a real-time constraint (step S503: YES), the processing period estimating unit 111 determines whether parameter collection for the data processing system group 120 has been performed by the information collecting unit 114 (step S504).

At step S504, if parameter collection has been performed (step S504: YES), the master terminal 410 proceeds to step S508. If parameter collection has not been performed (step S504: NO), the processing period estimating unit 111 calculates the estimated time until the process indicated in the execution request is completed (step S505). The comparing unit 115 determines whether the estimated time calculated at step S505 is less than a time constraint (specified period) prescribed by the real-time constraint (step S506).

At step S506, if the estimated time is not less than the time constraint (step S506: NO), the master terminal 410 proceeds to step S508. If the estimated time is less than the time constraint (step S506: YES), the appending unit 116 appends a forced flag (specific information) to the process indicated in the execution request (step S507).

The scheduler 113 schedules the process indicated in the execution request (step S508). Based on the scheduling at step S508, the scheduler 113 dispatches the process indicated in the execution request to at least one data processing system of the data processing system group 120 (step S509).

The scheduler 113 determines whether a data processing system to which the process is dispatched at step S509 has refused the process assignment (step S510). If a data processing system has refused the dispatched process (step S510: YES), the scheduler 113 returns to step S508, and again performs scheduling. If no data processing system has refused the dispatched process (step S510: NO), the scheduler 113 determines whether all process results consequent to the dispatching at step S509 have been returned (step S511); and if not, waits until all process results have been returned (step S511: NO).

At step S511, when all process results have been returned (step S511: YES), the master terminal 410 notifies the user of the returned process results (step S512). The notification at step S512 may be performed via the user interface 204 depicted in FIG. 2, for example.

The processing period estimating unit 111 calculates the required time from the scheduling until completion of the process, by subtracting from the current time, t0 obtained at step S502 (step S513). The required time calculated at step S513 corresponds to the sum of the scheduling period 322, the dispatch period 323, the processing period 324 depicted in FIG. 3.

The processing period estimating unit 111 stores the required time calculated at step S513 into the memory of the master terminal 410 (step S514), ending a series of the operations. By performing operations above, the master terminal 410 determines whether the process indicated in an execution request has a real-time constraint, and if the time constraint is shorter than the estimated time for completion of the process, the master terminal 410 can append a forced command and assign the process.

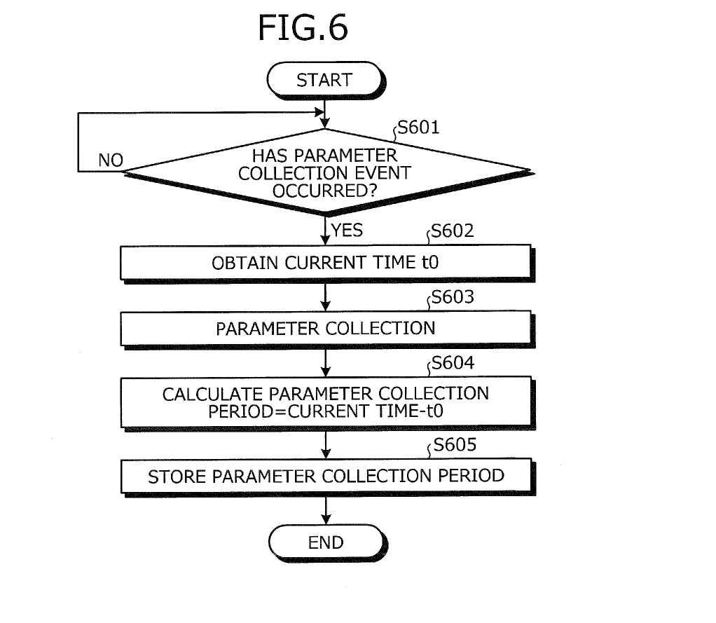

FIG. 6 is a flowchart of one example of a parameter collection procedure performed by the master terminal. The information collecting unit 114 of the master terminal 410, for example, executes the operations below as the parameter collection procedure. The information collecting unit 114 determines whether a parameter collection event has occurred (step S601); and if not, waits until a parameter collection event occurs (step S601: NO). A parameter collection event is an event that triggers parameter collection and, for example, occurs cyclically.

At step S601, when a parameter collection event occurs (step S601: YES), the information collecting unit 114 obtains the current time t0 (step S602). The information collecting unit 114 performs parameter collection by receiving parameters from the data processing system group 120 (step S603).

The information collecting unit 114 calculates the parameter collection period by subtracting from the current time, t0 obtained at step S602 (step S604). The required time calculated at step S604 corresponds to the parameter collection period 321 depicted in FIG. 3. The information collecting unit 114 stores the parameter collection period calculated at step S604 into the memory of the master terminal 410 (step S605), ending a series of the operations. By performing the operations above, the information collecting unit 114 is able to obtain the parameter collection period when a parameter collection event occurs.

An example of the calculation of the estimated time at step S505 depicted in FIG. 5 will be described. For example, the processing period estimating unit 111 calculates the sum of the required time stored at step S514 in FIG. 5 and the parameter collection period stored at step S605 in FIG. 6 and thereby, is able to calculate the estimated time 310 depicted in FIG. 3.

If the required time has been calculated and stored multiple times, the processing period estimating unit 111 may calculate the estimated time 310, based on the average of the required times stored. Further, if the parameter collection period has been calculated and stored multiple times, the processing period estimating unit 111 may calculate the estimated time 310, based on the average of the parameter collection periods stored.

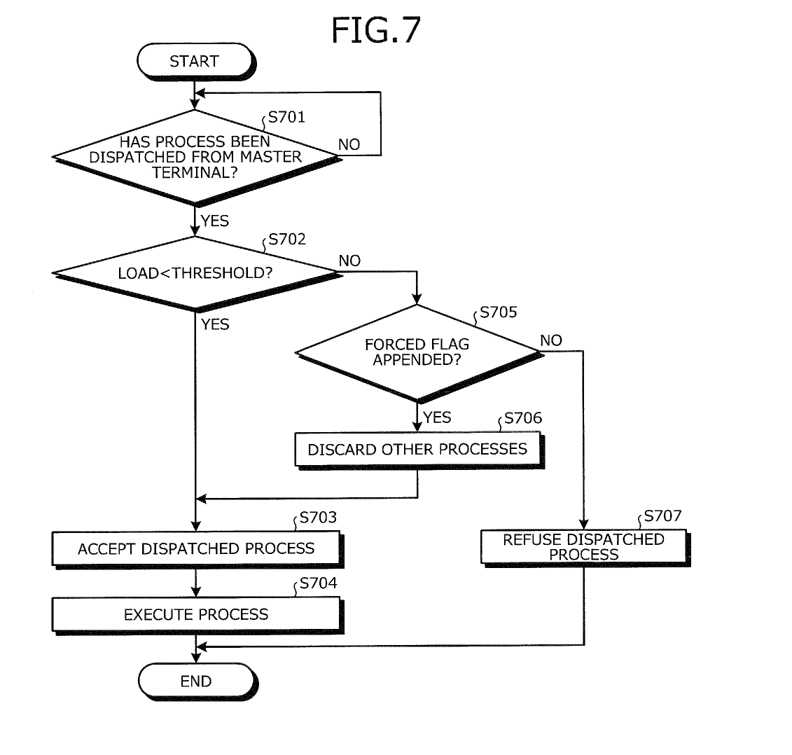

FIG. 7 is a flowchart of an example of a procedure performed by a computing terminal. The computing terminal 421, for example, executes the operations below. In the present example, although a procedure of the computing terminal 421 will be described, the procedure performed by the computing terminals 422 and 423 is identical. The receiving unit 121 determines whether a process has been dispatched from the master terminal 410 (step S701); and if not, waits until a process has been dispatched (step S701: NO). For example, the receiving unit 121 determines whether process assignment information has been received from the master terminal 410 to determine whether a process has been dispatched.

At step S701, when a process has been dispatched (step S701: YES), the receiving unit 121 determines whether the load (e.g., the number of processes under execution) of the computing terminal 421 is less than a threshold (step S702). If the load is less than the threshold (step S702: YES), the determining unit 122 accepts the process dispatched at step S701 (step S703). The processing unit 124 executes the accepted dispatched process (step S704), ending a series of the operations.

At step S702, if the load is greater than or equal to the threshold (step S702: NO), the determining unit 122 determines whether a forced flag is appended to the dispatched process (step S705). If a forced flag is appended (step S705: YES), the processing unit 124 discards other processes that are under execution or planned for execution (step S706), and proceeds to step S703.

At step S705, if not forced flag is appended (step S705: NO), the computing terminal 421 refuses the process dispatched at step S701 (step S707), ending a series of the operations. At step S707, the computing terminal 421, for example, refuses the dispatched process by transmitting, via the communications interface 205, refusal notification to the master terminal 410.

By performing the operations above, when a process to which a forced flag is appended in dispatched, the computing terminal 421 can preferentially execute the dispatched process by discarding other processes even when the load is high.

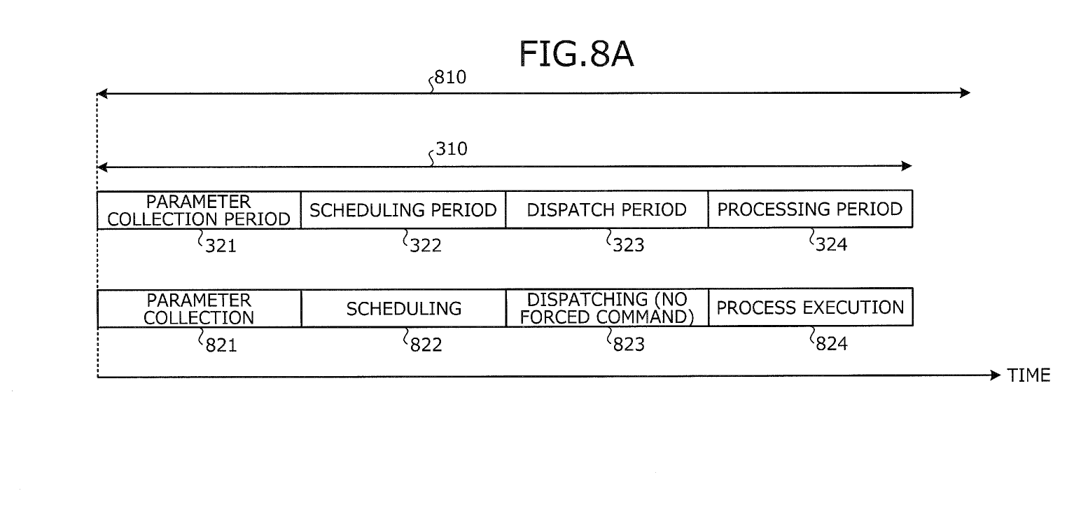

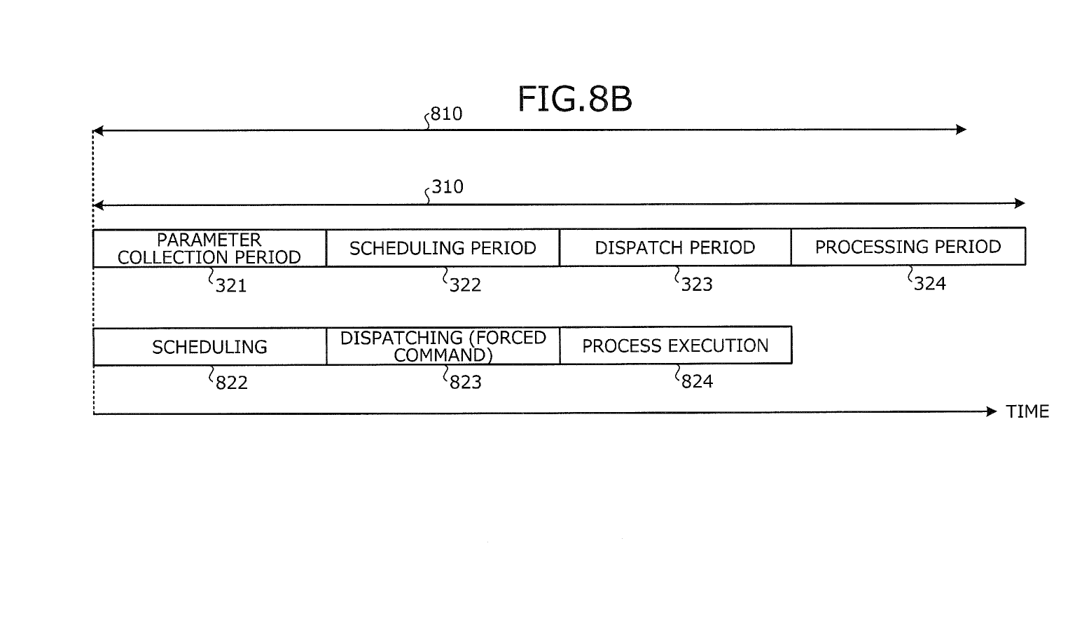

FIG. 8A is a diagram depicting an example of operation of the communications system when the estimated time is within a specified period. In FIG. 8A, portions identical to those depicted in FIG. 3 are given the same reference numerals used in FIG. 3 and description thereof is omitted. In FIG. 8A, a specified period 810 is the specified period (time constraint) to which the comparing unit 115 make comparison.

As depicted in FIG. 8A, if the estimated time 310 is less than or equal to the specified period 810, the scheduling system 110 performs parameter collection 821, scheduling 822, and dispatching 823; the data processing system 120a performs process execution 824. In the dispatching 823, no forced flag is appended (no forced command).

In this case, since the estimated time 310 is less than or equal to the specified period 810, the parameter collection 821, the scheduling 822, the dispatching 823, and the process execution 824 can be expected to be completed within the specified period 810. Further, since the parameter collection 821 is performed, refusal of the dispatching 823 to the data processing system 120a can be prevented.

FIG. 8B is a diagram depicting an example of operation of the communications system when the estimated time exceeds the specified period. In FIG. 8B, portions identical to those depicted in FIG. 3 or FIG. 8A are given the same reference numerals used in FIGS. 3 and 8A, and description thereof will be omitted.

As depicted in FIG. 8B, if the estimated time 310 is longer than the specified period 810, the scheduling system 110 performs the scheduling 822 and the dispatching 823, without performing the parameter collection 821. Further, in the dispatching 823, a forced flag is appended (forced command).

In this case, the scheduling 822, the dispatching 823, and the process execution 824 can be expected to be completed within the specified period 810, since the scheduling 822 is started sooner by a period equivalent to the time saved by not performing the parameter collection 821. Further, in the dispatching 823, since a forced flag is appended, delays consequent to assignment refusal by the data processing system 120a can be prevented.

Thus, the communications system 100 according to the embodiment estimates the time that is consumed for completing a process assigned to a computing terminal, and if completion of the process seems to take time, the communications system can forcibly assign the process and prevent delays that result from assignment refusal. Consequently, the communications system 100 can abide a time constraint (real-time constraint) of a process, even without collecting parameters of computing terminals that are candidates for assignment of the process.

As described, the scheduling system, the data processing system, and the scheduling method can suppress processing delays and since parameter collection need not be performed continuously, the scheduling system, the data processing system, and the scheduling method can reduce power consumption.

According to one aspect of the embodiment, processing delays can be suppressed.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A scheduling system comprising
a processor configured to:
assign a process to at least one data processing system among a plurality of data processing systems, based on an execution request for the process;
estimate time consumed for completion of a first process, when the process is the first process; and
append specific information to the first process, based on the estimated time.

2. The scheduling system according to claim 1, wherein
the processor is configured to:
compares the estimated time and a specified period, and
append the specific information to the first process, based on a comparison result.

3. The scheduling system according to claim 2, further comprising
an information collecting unit that collects information of the data processing systems, when the estimated time is less than the specified period.

4. The scheduling system according to claim 1, further comprising
an information collecting unit that collects information of the data processing systems, wherein
the processor, when the process is a second process, measures a collection period during which the information collecting unit collects the information and a process period that is from a scheduling of the second process until completion of the second process.

5. The scheduling system according to claim 4, wherein
the processor calculates an average of the collection period and an average of the process period, and based on the averages, estimates the time consumed until execution of the first process is completed.

6. The scheduling system according to claim 1, wherein
the specific information is information prescribing a forced flag of the first process in the at least one data processing system.

7. The scheduling system according to claim 1, wherein
the scheduling system is a mobile terminal that is wirelessly connected with the data processing systems.

8. The scheduling system according to claim 2, wherein
the first process is a process for which a constraint is set that prescribes completion within the specified period.

9. A data processing system comprising
a processor that is configured to:
receive a process assigned by a scheduler;
determine a load of the data processing system;
determine whether specific information is appended to the process; and
discard based on the load and presence of the specific information, at least one process that has already been assigned.

10. The data processing system according to claim 9, wherein
the processor discards the at least one process, when the load exceeds a given value and the specific information is appended.

11. The data processing system according to claim 9, wherein
the processor selects, as the at least one process, a process having a priority level that is lowest.

12. The data processing system according to claim 9, wherein
the data processing system is a mobile terminal that is wirelessly connected with the scheduler.

13. A scheduling method comprising:
estimating time consumed for completion of a first process, when based on an execution request for a process, the process is a first process;
appending specific information to the first process, based on the estimated time;
assigning the first process to a second data processing system included among a plurality of data processing systems, wherein
the scheduling method is executed by a first data processing system included among the data processing systems.

14. The scheduling method according to claim 13, further comprising
collecting information of the data processing systems, when the estimated time is less than a specified period, wherein
the assigning includes assigning the first process to the second data processing system, based on the collected information.

15. The scheduling method according to claim 13, wherein
the appending includes appending the specific information to the first process, when the estimated time is greater than the specified period, and
the assigning includes assigning the first process to the second data processing system.

16. The scheduling method according to claim 13, wherein
the data processing systems are mobile terminals that are wirelessly connected to one another.
